(19) United States
(12) Patent Application Publication
(10) Pub. No.: US 2006/0129292 A1
(43) Pub. Date: Jun. 15, 2006

(54) Vehicle driving support system

(76) Inventor: Hitomi Ohkubo, Iwaki-city (JP)

Correspondence Address: BRINKS HOFER GILSON & LIONE, P.O. BOX 10395, CHICAGO, IL, 60610, US

(21) Appl. No.: 11/296,857

(22) Filed: Dec. 7, 2005

(30) Foreign Application Priority Data
Dec. 10, 2004 (JP) 2004-358446

(51) Int. Cl. B60G 17/016

(52) U.S. Cl. 701/38

(57) ABSTRACT

A vehicle driving support system is provided which can identify the existence of an object in a surrounding area of the vehicle which may possibly collide with the vehicle. The system comprises a camera for photographing the surrounding area of a vehicle, a road surface projector for projecting an image of the area photographed onto a road surface image, a three-dimensional image sensor and a height measurement section for detecting the height of an object existing in the surrounding area, a height comparator for comparing the height detected with a reference value, a collision detector for detecting a collision risk point whose height is higher than the reference value, an image modifier for emphasizing the collision risk point in the image generated by the road surface projector, and a display processor and display for displaying the image modified.

### BACKGROUND OF THE INVENTION

1. Field of the Invention

The present invention relates to vehicle driving support systems for supporting driving of a vehicle by photographing an area surrounding the vehicle and displaying an image photographed on a screen.

2. Description of the Related Art

An apparatus for indicating a condition of a surrounding area of a vehicle has hitherto been known which photographs the surrounding area using a vehicle-mounted camera, and displays an image photographed on a display device, as disclosed in, for example, JP-A-2001-114047 (see pages 2 to 6, and FIGS. 1 to 10). In this apparatus, a road surface projection process is performed on the photographed image to provide and display an image viewed from above and towards a road surface. Also, a rough height of an object located on the road is displayed in the image.

In such an apparatus for indicating the vehicle surrounding condition as disclosed in the above-mentioned patent document, the display of the image projected on the road surface only shows whether or not the vehicle and the objects surrounding the vehicle overlap one another on the road surface. However, it is difficult to identify a relative relationship between the vehicle and the other object whose height is lower than that of the vehicle. For example, assuming that a vehicle is stopped in the vicinity of an object whose height is 20 cm and that a door of the vehicle is opened, it is not predictable in advance whether or not the opened door will hit the object. Likewise, when the vehicle passes an object whose height is 20 cm, it is not predictable whether or not the object will hit the lower part of the vehicle. Although a rough height (value) of the other object is capable of being displayed in the image in the vehicle-surrounding-condition indicating apparatus as disclosed in the above patent document, if a driver does not know a length from the road surface to the lowermost side of the vehicle's door, or the height under a vehicle's body (minimum road clearance), the driver cannot judge whether the object will hit the vehicle or not using the height of the object informed.

### SUMMARY OF THE INVENTION

The present invention has been accomplished so as to solve the problems encountered with the prior art, and it is an object of the invention to provide a vehicle driving support system which can surely identify the existence of an object in a surrounding area of a vehicle which may possibly hit the vehicle.

In one aspect of the invention, a vehicle driving support system is provided which comprises a camera for photographing an area surrounding a vehicle, the area including a road surface, a road surface projector operable to project an image of the area photographed by the camera to generate a projected image, a height detector operable to detect a height of an object existing in the area surrounding the vehicle, a height comparator operator to compare the height of the object with a reference value, a collision detector operable to detect a collision risk point associated with the object if the height of the object is determined to be approximately equal to or higher than the reference value by the height comparator, an image modifier operable to modify the projected image to emphasize the collision risk point, and a display operable to display the projected image after modification. Thus, the object located in the surrounding area and whose height is higher than the reference value is detected as the risky point, which is then displayed in an emphasized form. This allows a user (driver) to reliably identify the existence of the nearby object which has the height higher than the reference value and which may hit the vehicle.

More specifically, the emphasis of the risky point performed by the above-mentioned image modification section desirably involves coloring the risky point in a color other than that of the surrounding area. Particularly, the coloring preferably uses a plurality of colors depending upon the degree of possibility that the risky point may hit the vehicle. More preferably, the coloring involves coloring in red the risky point which will surely hit the vehicle, and coloring in yellow another risky point which may hit the vehicle. Alternatively, the emphasis of the risky point performed by the image modification section may involve causing the risky point to flash while a color of the point is changed at certain intervals. Preferably, the emphasis of the risky point performed by the image modification section may involve coloring a numeric value indicative of a height of the risky point. Further, the emphasis of the risky point performed by the image modification section may preferably involve causing the numeric value indicative of the height of the risky point to flash while a color of the numeric value is changed at certain intervals. The emphasis may permit the user to easily identify the risky point which may possibly hit the vehicle, and prevent the user from inadvertently missing the risky point.

The above-mentioned risky-point detection section preferably detects the risky point using the reference value corresponding to a height of lowermost parts of left and right doors of the vehicle. In this way, the user can learn the existence of the nearby object which may possibly hit the door when the door is opened, prior to the opening of the door.

Alternatively, the above-mentioned risky-point detection section may preferably detect the risky point using the reference value corresponding to a minimum road clearance of the vehicle. In this way, the user can learn whether or not the vehicle may pass over an obstacle or the like lying on a road surface, before the vehicle passes over that road surface.

The reference value may preferably be a design value set depending on a type of the vehicle. Thus, the reference value appropriate for the vehicle type can be used.

Preferably, the system further comprises a reference value setting section for setting the reference value in response to an operation of a user. Thus, even when the system is installed on a different vehicle, the reference value appropriate for the vehicle is available.

Preferably, the system further comprises a warning sound section for generating a warning sound when the risky point is detected by the risky-point detection section. The warning sound may prevent the user inadvertently missing the existence of the risky point.

The camera is preferably installed on at least one of the left, right, front, and rear sides of the vehicle so as to photograph the area with a viewing angle of approximately 180 degrees through a wide-angle lens. A range of interest for detection of the nearby risky points can be expanded by widening the area to be photographed by the camera.

### BRIEF DESCRIPTION OF THE DRAWINGS

FIG. 1 shows a diagram of a configuration of a vehicle driving support system according to one preferred embodiment of the invention;

FIG. 2 illustrates a condition of installation of cameras;

FIG. 3 is a flowchart showing operational steps of the vehicle driving support system;

FIG. 4 shows an example of display; and

FIG. 5 shows another example of display.

### DESCRIPTION OF THE PREFERRED EMBODIMENTS

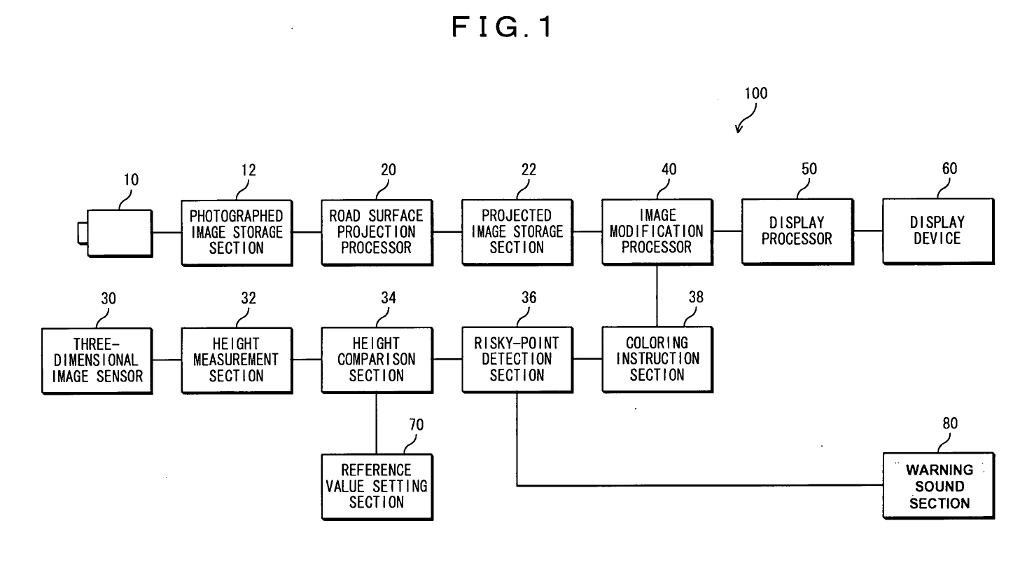

Reference will now be made in detail to exemplary embodiments, which are illustrated in the accompanying drawings. FIG. 1 shows a configuration of a vehicle driving support system according to the embodiment. A vehicle driving support system 100 shown in FIG. 1 includes a camera 10, a photographed image storage section 12, a road surface projection processor 20, a projected image storage section 22, a three-dimensional image sensor 30, a height measurement section 32, a height comparison section 34, a risky-point detection section 36, a coloring instruction section 38, an image modification processor 40, a display processor 50, a display device 60, a reference value setting section 70, and a warning sound section 80.

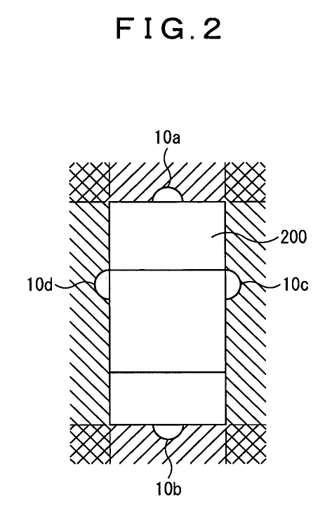

The camera 10 is operable to photograph an area surrounding a vehicle to create a side-view image. FIG. 2 illustrates a condition of installation of the cameras 10. A user's vehicle 200 has the cameras 10 (10a, 10b, 10c, and 10d) installed on four positions, namely, on the front, rear, left and right sides thereof. The camera 10a installed on the front part of the vehicle 200 photographs a front area surrounding the vehicle 200 through a wide-angle lens with a viewing angle of approximately 180 degrees, including the entire front side of the vehicle 200 with respect to its front end. Likewise, the camera 10b installed on the rear part of the vehicle 200 photographs a rear area surrounding the vehicle 200 through a wide-angle lens with a viewing angle of approximately 180 degrees, including the entire rear side of the vehicle 200 with respect to its rear end. The camera 10c installed on the right side of the vehicle 200 photographs a right-sided area surrounding the vehicle 200 through a wide-angle lens with a viewing angle of approximately 180 degrees, including the entire right side of the vehicle 200 with respect to its right end. The camera 10d installed on the left side of the vehicle 200 photographs a left-sided area surrounding the vehicle 200 through a wide-angle lens with a viewing angle of approximately 180 degrees, including the entire left side of the vehicle 200 with respect to its left end. Thus, the four cameras, 10a to 10d, are installed on the front, rear, left, and right sides of the vehicle 200, thereby photographing a road surface and objects on the road surface located in a range of 360 degrees around the vehicle 200. Side-view image data photographed by the cameras 10a to 10d is stored in the photographed image storage section 12.

The road surface projection processor 20 performs a viewpoint conversion process for generating a top-view image based upon the side-view images stored in the photographed image storage section 12. The viewpoint conversion process involves converting the side-view image corresponding to a viewpoint position located in the vicinity of the wide-angle lens of the camera 10 into the top-view image corresponding to a viewpoint position located above the road surface. The top-view image data thus obtained is stored in the projected image storage section 22.

The three-dimensional image sensor 30 includes a light-emitting part, and a light-receiving part. The light-emitting part produces light, which is reflected off an object whose height is to be measured. The reflected light returns to and is detected by the light-receiving part. For example, as is the case with the camera 10, the four three-dimensional image sensors 30 are installed on the front, rear, left, and right sides of the vehicle 200 as shown in FIG. 2. The object to be measured includes the road surface itself, and a sidewalk raised by one step from the road surface, as well as the objects put on the road surface. The three-dimensional image sensor 30 can be, for example, an “EQUINOX” image sensor chip manufactured by Canesta, Inc. The height measurement section 32 measures a distance to each component of the nearby object, and a height of the component, the nearby object to be measured being located in the vehicle surrounding area, by analyzing the reflected light detected by the light-receiving part of the three-dimensional image sensor 30. The height comparison section 34 compares the height of each component of the nearby object measured by the height measurement section 32 with a reference value. The reference value used may be a design value set depending upon a type of the vehicle. For example, a design value for the height of the lowermost parts of the left and right doors of the vehicle may be set as the reference value.

The risky-point detection section 36 detects as a risky point a point whose height is determined to be higher than the reference value by the height comparison section 34. The coloring instruction section 38 specifies the risky point detected by the risky-point detection section 36, and sends an instruction for coloring the risky point in a predetermined color to the image modification processor 40 so as to emphasize the risky point with respect to other areas.

The image modification processor 40 performs an image modification process for coloring the risky point in the predetermined color, given the coloring instruction from the coloring instruction section 38, in the top-view image read from the projected image storage section 22. For example, an area corresponding to the risky point may have its color changed to red.

The display processor 50 converts the top-view image data obtained after the image modification process by the image modification processor 40 into a video signal in a predetermined format (for example, an NTSC type video signal). The video signal is sent to the display device 60, and then the top-view image after the image modification process has been performed is displayed on a screen. The display device 60 is composed of, for example, a liquid crystal display device (LCD), which is installed at a position in an interior of the vehicle that may be easily viewed by a driver.

The reference value setting section 70 sets or alters the reference value to be used by the height comparison section 34. Although as mentioned above, the reference value is set to, for example, a design value in an initial state (a design value for a height of the lowermost parts of the left and right doors), it may be altered and set in response to an operation of the driver (user). The reference value setting section 70 can reset the reference value in accordance with the operation by the driver, for example, when the driver directly enters another reference value using a ten key pad of an operational unit (not shown), or when the driver increases or decreases the current reference value using an up key or down key of the operational unit. The warning sound section 80 generates a predetermined warning sound when the risky point is detected by the risky-point detection section 36. This warning sound may be a simple one or a guidance voice announcing a more specific warning.

It should be noted that the above-mentioned road surface projection processor 20 corresponds to a road surface projector described in appended claims; the three-dimensional image sensor 30 and the height measurement section 32 to a height detector therein; the height comparison section 34 to a height comparator therein; the risky-point detection section 36 to a collision detector therein; the image modification processor 40 to an image modifier therein; the display processor 50 and the display device 60 to a display therein; the reference value setting section 70 to a reference value section therein; and the warning sound section 80 to a warning sound generator.

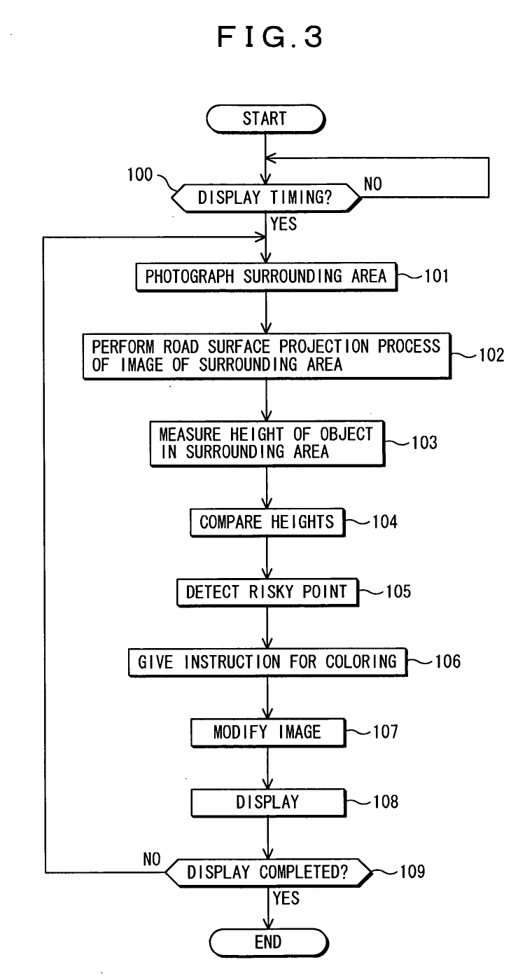

Now, an operation of the vehicle driving support system 100 of the embodiment with this arrangement will be described in detail. FIG. 3 is a flowchart of operational steps of the vehicle driving support system 100, which illustrates the operational steps involving photographing a surrounding area of the vehicle, and displaying a top-view image in which a risky point is emphasized.

It is determined whether display timing has come or not by a controller (not shown) for controlling the entire operation of the vehicle driving support system 100 (step 100). Until the display timing has come, a negative determination is continuously repeated. In contrast, if the display timing has come, then an affirmative determination is made. For example, the time when a shift lever of a transmission is shifted to the P (parking) position may be the display timing. At this timing, the affirmative determination is made at the step 100.

Then, an area surrounding the vehicle 200 is photographed by the camera 100 (step 101). The side-view image data thus obtained is stored in the photographed image storage section 12. The road surface projection processor 20 performs the road surface projection process (viewpoint conversion process) using the side-view image stored in the photographed image storage section 12 to generate a top-view image (step 102). The top-view image data thus obtained is stored in the projected image storage section 22.

In parallel to the generation operation of the top-view image as mentioned above, the height measurement section 32 measures a distance to each component of the object in the vehicle surrounding area and a height of the component based upon signals sent from the three-dimensional sensor 30 (step 103). Then, the height comparison section 34 compares the height of each component measured with a reference value (step 104). The risky-point detection section 36 detects a point whose height is higher than the reference value as the risky point (step 105). The coloring instruction section 38 gives an instruction for coloring the risky point detected to the image modification processor 40 (step 106). The image modification processor 40 performs the image modification process for coloring the risky point in a predetermined color, after receiving the coloring instruction sent by the coloring instruction section 38, in the top-view image generated by the operation at the step 102 (step 107). The top-view image resulting from the image modification process is displayed on the display device 60 by the display processor 50 (step 108). Thereafter, the controller determines whether the display is completed or not (step 109). If the display is not completed, a negative determination is made, and the operation returns to the step 101, so that the steps following the step of photographing the surrounding area of the vehicle 200 are repeatedly carried out. If the display is completed, an affirmative determination is made, and a series of the operational steps is ended.

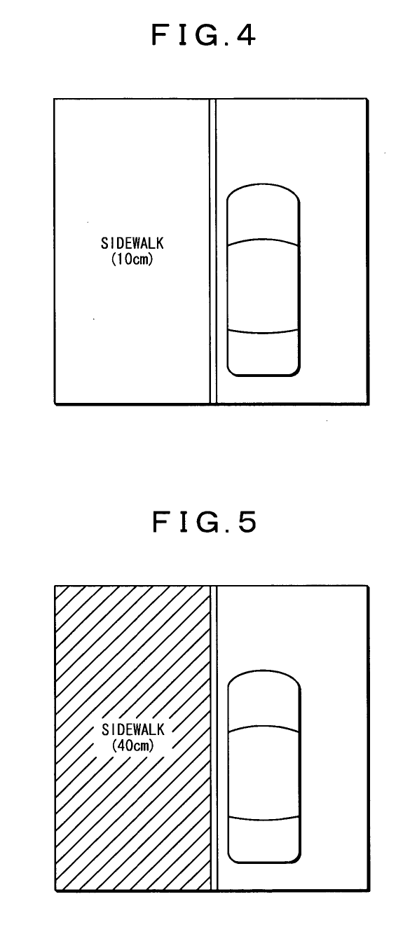

FIGS. 4 and 5 show examples of a display. For example, assuming that the design value of the height of the lowermost parts of the left and right doors is 15 cm, which is set as the reference value, when the height of a sidewalk is 10 cm which is less than the reference value as shown in FIG. 4, the sidewalk is not colored or otherwise emphasized on the display. On the other hand, for a sidewalk whose height is 40 cm which is above the reference value as shown in FIG. 5, the sidewalk is colored or otherwise emphasized on the display.

Thus, in the vehicle driving support system 100 of the embodiment, the nearby object whose height is higher than the reference value is detected as the risky point, which is then displayed in an emphasized form. This allows the driver to surely identify the existence of the nearby object which has a height higher than the reference value and which may hit the vehicle. For example, emphasizing the risky point by coloring permits the driver to easily identify the risky point which may possibly hit the vehicle, without the user inadvertently missing the existence of the risky point.

The risky point is detected using the reference value corresponding to the height of the lowermost parts of the left and right doors of the vehicle. This can let the driver know the existence of the nearby object which may possibly hit the door when the door is opened, prior to the opening of the door. Particularly, the design value set depending on the type of the vehicle is used as the reference value, so that the reference value appropriate for the vehicle type can be set.

The reference value setting section 70 for setting the reference value in response to the user's operation can be used to alter the reference value. Thus, even when the vehicle driving support system 100 is installed on a different vehicle, the reference value appropriate for the vehicle is available. When the risky point is detected, the warning sound section 80 is operable to generate the warning sound, thereby surely preventing the user from inadverently missing the existence of the risky point.

The camera 10 is installed on at least one of the left, right, front, and rear sides of the vehicle (at the four positions on the left, right, front, and rear sides as shown in FIG. 2) to photograph the area with the viewing angle of approximately 180 degrees through the wide-angle lens. In this way, a range of interest for searching for the nearby risky points can be expanded by widening the area to be photographed by the camera 10.

The invention is not limited to the exemplary embodiments described above, and various modifications can be made to the disclosed embodiments without departing from the spirit and scope of the invention. Although in the above-mentioned embodiments the display is emphasized by coloring in red the risky point whose height is above the reference value, the emphasis of the display may involve any one of the following ways (1) to (3).

Depending on a degree of possibility that the risky point may hit the vehicle, a different plurality of colors may be used to color the risky points. For example, the display may be emphasized by coloring in red the risky point which will surely hit the vehicle, and in yellow another risky point which may or may not hit the vehicle.

(2) The display may be emphasized by causing the risky point to flash while the color of the point is changed at certain intervals.

(3) The display may be emphasized by coloring or flashing a numeric value indicative of the height of the risky point.

Although in the above embodiments the design value for the height of the lowermost parts of the left and right doors is used as the reference value, a reference value corresponding to the minimum road clearance of the vehicle may be used to detect the risky point. In this way, the user can easily learn whether or not the vehicle may pass over an obstacle or the like lying on a road surface, before the vehicle passes that section of road. Alternatively, a plurality of reference values may be set to detect the risky point. For example, the reference value corresponding to the minimum road clearance of the vehicle may be used as the first reference value, and the design value for the height of the lowermost parts of the left and right doors may be used as the second reference value. For the emphasis of the display in this case, the risky point whose height is higher than the second reference value is colored in red, and the risky point whose height is less than the second reference value, but higher than the first reference value is colored in yellow. Such use of the plurality of reference values can inform the driver of the possibility of contact with a plurality of points of the vehicle all at once.

In the embodiments described above, when the shift lever of the transmission is shifted to the P position, which has been explained by way of example, the camera 10 starts to take a photograph. Alternatively, when a travel speed of the vehicle 200 is equal to or less than a predetermined value, or when the driver operates a predetermined switch, or the like, the affirmative determination may be made at the step 100 (in determining whether or not the display timing has come or not).

Although in the above embodiments the three-dimensional image sensor 30 is used to measure the height of the object located in the surrounding area of the vehicle, any other means for measurement of a height may be used. For example, a radar device may be used. Alternatively, two or more cameras may be used to photograph the surrounding area of the vehicle, and the contents of images thus obtained may be analyzed to measure the height of the object in the surrounding area.

While there has been illustrated and described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teachings of the invention without departing from the central scope thereof Therefore, it is intended that this invention not be limited to the particular embodiments disclosed, but that the invention will include all embodiments falling within the scope of the appended claims.

What is claimed is:

1. A vehicle driving support system comprising:
a camera operable to photograph an area surrounding a vehicle, the area including a road surface;
a road surface projector operable to project an image of the area photographed by the camera to generate a projected image;
a height detector operable to detect a height of an object existing in the area surrounding the vehicle;
a height comparator operable to compare the height of the object with a reference value;
a collision detector operable to detect a collision risk point associated with the object if the height of the object is determined to be approximately equal to or higher than the reference value by the height comparator;
an image modifier operable to modify the projected image to emphasize the collision risk point; and
a display operable to display the projected image after modification.

2. The vehicle driving support system according to claim 1, wherein the collision detector is operable to detect the collision risk point using the reference value corresponding to a height of lowermost parts of left and right doors of the vehicle.

3. The vehicle driving support system according to claim 1, wherein the collision detector is operable to detect the collision risk point using the reference value corresponding to a minimum road clearance of the vehicle.

4. The vehicle driving support system according to claim 1, further comprising a reference value section operable to set the reference value in response to an operation of a user.

5. The vehicle driving support system according to claim 1, further comprising a warning sound generator operable to generate a warning sound when the collision risk point is detected by the collision detector.

6. The vehicle driving support system according to claim 1, wherein the camera is installed on at least one of left, right, front, and rear sides of the vehicle so as to photograph the area with a viewing angle of approximately 180 degrees through a wide-angle lens.

7. The vehicle driving support system according to claim 1, wherein the emphasis of the collision risk point involves causing the collision risk point to flash while a color of the collision risk point is changed at certain intervals.

8. The vehicle driving support system according to claim 1, wherein the emphasis of the collision risk point involves causing a numeric value indicative of a height of the collision risk point to flash while a color of the numeric value is changed at certain intervals.

9. The vehicle driving support system according to claim 1, wherein the emphasis of the collision risk point involves coloring a numeric value indicative of the height of the collision risk point.

10. The vehicle driving support system according to claim 9, further comprising a warning sound generator operable to generate a warning sound when the collision risk point is detected.

11. The vehicle driving support system according to claim 9, wherein the collision detector is operable to detect the collision risk point using the reference value corresponding to a minimum road clearance of the vehicle.

12. The vehicle driving support system according to claim 9, further comprising a reference value section operable to set the reference value in response to an operation of a user.

13. The vehicle driving support system according to claim 9, wherein the camera is installed on at least one of left, right, front, and rear sides of the vehicle so as to photograph the area with a viewing angle of approximately 180 degrees through the wide-angle lens.

14. The vehicle driving support system according to claim 9, wherein the collision detector is operable to detect the collision risk point using the reference value corresponding to the height of the lowermost parts of the left and right doors of the vehicle.

15. The vehicle driving support system according to claim 14, wherein a design value associated with a type of the vehicle is used as the reference value.

16. The vehicle driving support system according to claim 1, wherein the emphasis of the collision risk point involves coloring the collision risk point in a color other than that of the surrounding area.

17. The vehicle driving support system according to claim 16, wherein the coloring uses a plurality of colors depending upon the likelihood that the object will collide with the vehicle.

18. The vehicle driving support system according to claim 16, wherein the coloring involves coloring in a first color a first collision risk point associated with a first object, and coloring in a second color a second collision risk point associated with a second object, the first and second colors indicate that the system has determined that the first object is more likely to collide with the vehicle than the second object.

19. The vehicle driving support system according to claim 16, wherein the collision detector is operable to detect the collision risk point using the reference value corresponding to the height of the lowermost parts of the left and right doors of the vehicle.

20. The vehicle driving support system according to claim 16, wherein the collision detector is operable to detect the collision risk point using the reference value corresponding to a minimum road clearance of the vehicle.

21. A vehicle driving support system comprising:
a projector operable to generate a projection that includes an object located in an area surrounding a vehicle;
a height detector operable to detect a height of the object;
a height comparator operable to compare the height of the object with a reference value; and
an image modifier operable to modify the projection to emphasize the object if the height of the object is determined to be approximately equal to or higher than the reference value.

22. A method of supporting vehicle driving comprising:
detecting an object in an area surrounding a vehicle;
projecting the object onto a road surface image;
determining a height of the object;
comparing the height of the object with a reference value; and
modifying the projection to emphasize the object if the height of the object is determined to be approximately equal to or higher than the reference value.
